(19) United States
(12) Patent Application Publication
(10) Pub. No.: US 2005/0098562 A1
(43) Pub. Date: May 12, 2005

(54) Fuel cap with seal-retention gasket and means

(76) Inventor: Ralf Gerdes, Langenfeld (DE)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/825,942

(22) Filed: Apr. 14, 2004

(30) Foreign Application Priority Data
Nov. 12, 2003 (DE) 203 17 572.7

(51) Int. Cl. B65B 3/00; B67C 3/00; B65D 53/00

(52) U.S. Cl. 220/304; 220/86.2; 220/DIG. 33

(57) ABSTRACT

A fuel cap includes an interior closure body and means for effectuating a sealing contact between the closure body and the filler neck and maintaining the sealing contact through a degree rotation of the body in a cap removal direction up to at least approximately 20°. The means for effectuating a sealing contact and maintaining the sealing contact may include a gasket surrounding the closure body whose configuration and material formation are such that the seal is maintained. Alternatively, the means for effectuating a sealing contact and maintaining the sealing contact may include a traditional gasket surrounding the closure body and a spring surrounding the closure body, positioned above the gasket and configured to bias the gasket downward.

### RELATED APPLICATIONS

This application claims priority under the Paris Convention based German Utility Model Application No. 203 17 572.7 filed Nov. 12, 2003.

### BACKGROUND OF THE INVENTION

1. Field of the Invention

The invention relates to fuel caps for sealing a filler neck of a fuel tank for an automotive vehicle, and more particularly to fuel caps having a gasket, or other means, for maintaining the seal between the fuel cap and the filler neck through a degree of rotation of the fuel cap in the removal direction.

1. Description of Related Art

A fuel cap that maintains the seal between the fuel cap and the filler neck through a degree of rotation of the fuel cap in the removal direction is shown in German design patent 201 18 624.1, which corresponds to U.S. patent application Publication US 2003/0089716. Another fuel cap of this type is also shown in U.S. Pat. No. 6,209,746. In order to avoid the escape of fuel as a result of the unintentional turning of a handle portion of a cap, the known fuel caps have “free travel.” This free travel allows for rotation of the handle portion of a cap relative to the interior closure body and the gasket of a cap such that the body and gasket are rotated only after the handle portion is turned several degrees.

Even though these know fuel caps provide sufficient sealing, they have associated disadvantages. One disadvantage is that the free travel feature of these caps is often seen by customers as indicative of inferior quality. Another disadvantage of some of these known fuel caps is the requirement of a spring-loaded mechanism to facilitate the free travel feature. Such spring-loaded mechanisms necessarily increase the cost of the fuel cap.

An object of the invention is therefore to provide a fuel cap that can be manufactured at a reasonable price, presents as impression of high quality to the user and provides an effective seal to prevent the release of fuel upon an unintended rotation of the fuel cap.

### SUMMARY OF THE INVENTION

Briefly, and in general terms, the invention is directed to a fuel cap for installation and removal relative to a fuel tank filler neck having an upper surface. The fuel cap includes an interior closure body and means for effectuating a sealing contact between the closure body and the filler neck and maintaining the sealing contact through a degree rotation of the body in a cap removal direction up to approximately 20°. In one aspect of the invention, the means for effectuating a sealing contact and maintaining the sealing contact includes a gasket surrounding the closure body. In more detailed aspects, the gasket is manufactured from a material with an elasticity of approximately 40 to 80 shore and includes an upper circular lip and a lower circular lip each with a thickness of between approximately 0.1 mm and 0.5 mm. The lips join together at their inner circumferences to form a rounded junction point having a radius of between approximately 0.2 mm and 1 mm and diverge at their outer circumferences to provide a generally V-shaped cross-section. The thickness of the gasket at its outer circumference is approximately 1.1 to 1.5 times the thickness of the gasket in the area of the inner circumference. In another aspect of the invention, the means for effectuating a sealing contact and maintaining the sealing contact includes a gasket surrounding the closure body and a spring surrounding the closure body, positioned above the gasket and configured to bias the gasket downward.

These and other aspects and advantages of the invention will become apparent from the following detailed description and the accompanying drawings which illustrate by way of example the features of the invention.

### BRIEF DESCRIPTION OF THE DRAWINGS

FIG. 1 is an cross-sectional, exploded view of a fuel cap including an interior closure body, a gasket and configured in accordance with one embodiment of the invention.

FIG. 2 is a cross-sectional view of the gasket of FIG. 1.

FIG. 3 is a cross-sectional view of a fuel cap including an interior closure body, a gasket and a gasket biasing system, configured in accordance with another embodiment of the invention.

### DETAILED DESCRIPTION OF THE PREFERRED EMBODIMENTS

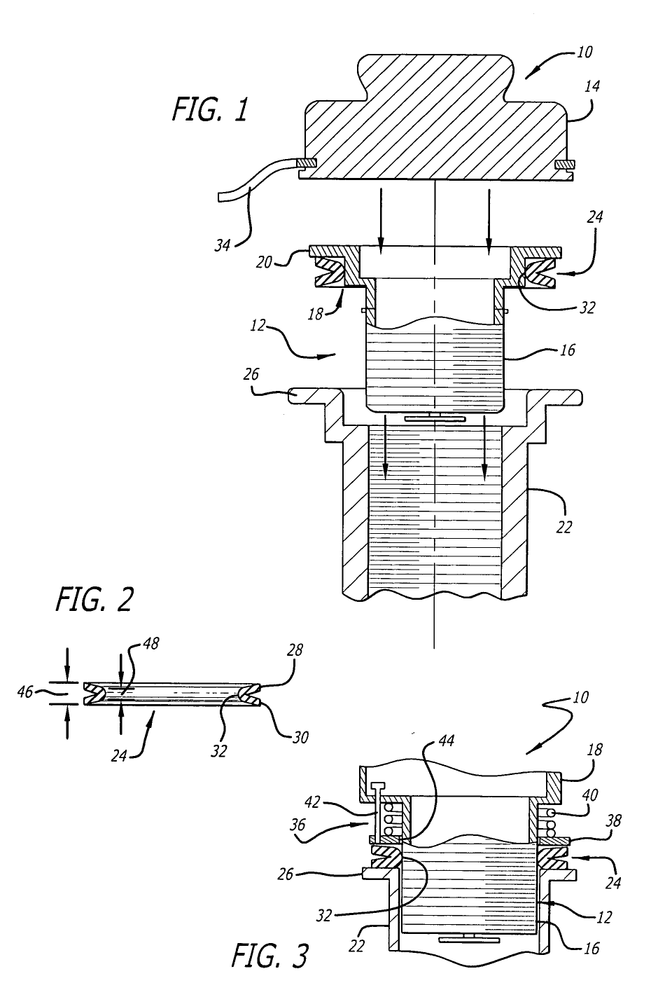

Referring now to the drawings, wherein the reference numerals denote like or corresponding parts throughout the figures, and particularly to FIG. 1, there is shown a fuel cap 10 with leakage protection. The fuel cap 10 includes an interior closure body 12 and a handle 14. The interior closure body 12 includes a round cylindrical lower portion 16 having a first diameter, a round cylindrical upper portion 18 having a second diameter greater than the first diameter, and a support flange 20. The upper portion 18 extends outward at a right angle from the lower portion 16 while the flange 20 extends outward at a right angle from the upper portion 18.

The closure body 12 fits within a filler neck 22 and is configured to engage the filler neck. This engagement may be facilitated by the presence of screw threads on the exterior of the lower portion 16 of the closure body 12 that mate with screw threads on the interior of the filler neck 22.

In one configuration, the handle 14 is a separate part from the interior closure body 12 that may be connected with the interior closure body, for example by means of a snap fit connection between the handle and the flange 20. In this configuration, the handle and body may be arranged such that relative movement is allowed between the handle and body. Such relative movement may provide a free travel feature like that shown and described in U.S. Pat. No. 6,209,746. The separate handle and closure body configuration may also allow for the inclusion of a torque override feature, whereby during cap installation, the handle continues to rotate once the installation torque of the closure body had been exceeded. Such a torque override feature is well known in the art.

In another configuration, the handle 14 and closure body 12 may be formed as an integral, one piece unit. Other connections between the handle 14 and closure body 12 are possible as well.

The handle 14 may include a tether strap 34 that may be connected to a portion of the vehicle body behind the fuel tank lid. The strap 34 is preferably contained movably in a notch of the handle 14.

As previously mentioned, prior fuel caps include a so-called free travel feature configured to avoid unintended rotation of the interior closure body through rotation of the handle, such as may be caused by the deformation of a vehicle metal body around the interior closure body 12. The prior art caps focus on unintended rotation of the handle, while this invention focuses on unintended rotation of the interior body, independent of the handle.

In accordance with the invention, a nozzle gasket 24 is located beneath the support flange 20 and thus is positioned to lie between an upper edge 26 of the filler neck 22 and the support flange. When the cap 10 is installed in the filler neck 22, the gasket 24 is compressed between the support flange 20 and the upper edge 26 of the filler neck to thereby establish a sealing contact between the gasket and the lower surface of the support flange 20 and the gasket and the upper surface of the upper edge 26. The gasket 24 is formed to have an elasticity such that the sealing contact between the gasket and the upper edge 26 of the filler neck 22 and the support flange 20 is disengaged only after a 20° or greater rotation of the closure body 12.

With reference to FIG. 2, the gasket 24 may be described as including a circular upper lip 28 and a circular lower lip 30. The lips 28, 30 join together at their respective inner circumferences to form a generally rounded inner gasket portion 32 with a radius between 0.2 and 1 mm and more specifically with a radius of 0.5 mm, which guarantees sufficient elasticity and permanent tension. The upper lip 28 and lower lip 30 extend outward from the rounded inner gasket portion 32 such that their facing surfaces diverge to form a gasket 24 having a generally V-shape cross-section.

Each lip 28, 30 has a thickness between 0.1 and 0.5 mm, with a preferred thickness of 0.2 mm. The thickness of the gasket 24 at its outer circumference 46 is 1.1 to 1.5 times the thickness of the gasket at its inner circumference 48. Preferably, the outer circumference 46 thickness is 1.2 times the thickness inner circumference 48 thickness. With a specifically suited design of the fuel cap, the gasket is made of an elastic material with an elasticity of 40 to 80 shore, specifically of 60 shore. Such a material, for example, is FKM-Viton.

With reference to FIG. 3, an additional design of a fuel cap according to the invention includes a closure body 12, a gasket 24, and gasket biasing system 36. The closure body 12 includes a lower portion 16 and an upper portion 18 similar to that shown in FIG. 1. A support flange is not included in the embodiment of FIG. 3, but may be incorporated into the design if desired. The gasket 24 previously described with reference to FIGS. 1 and 2 may be used in this design. Alternatively, a traditional gasket may be used.

The gasket biasing system 36 includes a pressure part 38, spring 40 and a travel limiter 42. In one embodiment, the elastic body 40 is a coiled spring which acts to bias the pressure part 38 toward the gasket 24 to thereby compress the gasket against the upper edge 26 of the filler neck 22. In order to provide a sealed contact between the interior circumference 44 of the pressure part 38 and the outer surface of the closure body 16, the pressure element 38 at its interior circumference is located through a slit gasket (not shown) or through a friction-covered sliding gasket (not shown) movable on the interior closure body 12. A travel limiter 42 slideably engaged at one end to the closure body 12 and fixedly secured at the other end to the pressure part 38, stops the pressure element 38 from falling off the interior closure body 1 when the body is unscrewed. Also, other types of travel limiters 42 may also be used.

In this configuration, when the fuel cap 10 is installed in the filler neck 22, the gasket 24 is compressed between the pressure part 38 and the upper edge 26 of the filler neck to thereby establish a sealing contact between the gasket and the lower surface of the pressure part 12 and the upper surface of the upper edge. A seal between the exterior of the closure body 12 and the pressure part 38 is provided by the slit gasket or sliding gasket between the two. Thus, the design provides triple protection against the leakage of fuel. Another additional protection can exist in that the gasket 24 is pressed toward the inside through the compression of the pressure piece 38 when tightening the fuel cap and thus causing an additional seal against the interior closure body 12.

In addition, when the gasket 24 is compressed by the pressure part 38 it may be pressed toward the closure body 12 thus forming a seal between the round inner portion 32 of the gasket and the exterior of the closure body. This seal may, in effect, substitute for the seal provided between the pressure part 38 and the closure body 12 surface.

In this configuration, it is possible to maintain the sealing contact of the gasket 24 through a turning angle greater than the 20 degree turning angle of the previously described configuration. This may be obtained by using a gasket 24 having the properties like that shown and described with reference to FIGS. 1 and 2. Thus, the combination of the gasket 24 and the gasket biasing system 36 effectuate sealing contact through a greater rotation than the gasket biasing system alone.

It will be apparent from the foregoing that while particular forms of the invention have been illustrated and described, various modifications can be made without departing from the spirit and scope of the invention. Accordingly, it is not intended that the invention be limited, except as by the appended claims.

1. A fuel cap for installation and removal relative to a fuel tank filler neck having an upper surface, said fuel cap comprising:
an interior closure body including a lower portion adapted to be screwed into the filler neck, an upper portion, extending outward from the lower part and a flange extending outward from the upper part;
an elastic gasket surrounding the interior closure body and positioned beneath the flange;
wherein the gasket is formed such that upon rotation of the interior closure body in a cap installation direction, the lower portion engages the filler neck and the gasket is compressed to effectuate a sealing contact between at least one of the gasket and the upper surface and the gasket and the flange and upon rotation of the body in a cap removal direction, at least one of the at least one sealing contacts between the gasket and the upper surface and the gasket and the flange remains until the body is rotated more than approximately 20°.

2. The fuel cap of claim 1 wherein the gasket comprises an upper circular lip and a lower circular lip, wherein the lips are joined together at their inner circumferences and diverge at their outer circumferences to provide a generally V-shaped cross-section.

3. The fuel cap of claim 2 wherein the junction at which the upper and lower lips join together has a radius between approximately 0.2 mm and 1 mm.

4. The fuel cap of claim 3 wherein the junction at which the upper and lower lips join together has a radius of approximately 0.5 mm.

5. The fuel cap of claim 2 wherein the upper and lower lips have a thickness between approximately 0.1 mm and 0.5 mm.

6. The fuel cap of claim 5 wherein the upper and lower lips have a thickness of approximately 0.2 mm.

7. The fuel cap of claim 2 wherein the thickness of the gasket at its outer circumference is approximately 1.1 to 1.5 times the thickness of the gasket in the area of the inner circumference.

8. The fuel cap of claim 7 wherein the thickness of the gasket at its outer circumference is approximately 1.2 times the thickness of the gasket in the area of the inner circumference.

9. The fuel cap of claim 1 wherein the gasket is manufactured from an elastic material with an elasticity of approximately 40 to 80 shore.

10. The fuel cap of claim 9 wherein the elasticity is approximately 60 shore.

11. The fuel cap of claim 1, wherein the gasket is made of FKM-Viton.

12. A fuel cap for closing a fuel tank filler neck having an upper surface, said fuel cap comprising:
an interior closure body including a lower portion adapted to be screwed into the filler neck and an upper portion extending outward from the lower part;
a spring surrounding the lower portion; and
a gasket surrounding the lower portion and positioned beneath the spring, wherein the spring biases the gasket downward relative to the upper portion.

13. The fuel cap of claim 12 wherein the spring is configured such that upon rotation of the interior closure body in a cap installation direction, the lower portion engages the filler neck and the gasket is compressed to effectuate a sealing contact between at least one of the gasket and the upper surface and the gasket and the upper portion and upon rotation of the body in a cap removal direction, at least one of the at least one sealing contacts between the gasket and the upper surface and the gasket and the upper portion remains until the body is rotated more than approximately 20°.

14. The fuel cap of claim 12 wherein the spring comprises a spiral spring wound around the upper portion.

15. The fuel cap of claim 12 further comprising a pressure part positioned between the spring and the gasket.

16. The fuel cap of claim 15 further comprising at least one path limiter coupled to the upper portion at one end and secured to the pressure part at the other end.

17. The fuel cap of claim 12 wherein the gasket is manufactured from an elastic material with an elasticity of approximately 40 to 80 shore and comprises an upper circular lip and a lower circular lip each with a thickness of between approximately 0.1 mm and 0.5 mm, wherein the lips join together at their inner circumferences to form a rounded junction point having a radius of between approximately 0.2 mm and 1 mm and diverge at their outer circumferences to provide a generally V-shaped cross-section, wherein the thickness of the gasket at its outer circumference is approximately 1.1 to 1.5 times the thickness of the gasket in the area of the inner circumference, wherein the combination of the spring and gasket are such that the degree of rotation of the body in the cap removal direction necessary to break the seal provided by the gasket is increased.

18. A fuel cap for installation and removal relative to a fuel tank filler neck having an upper surface, said fuel cap comprising:
an interior closure body adapted to engage the filler neck through rotation; and
means for effectuating a sealing contact between the closure body and the filler neck and maintaining the sealing contact through a degree rotation of the body in a cap removal direction up to at least approximately 20°.

19. The fuel cap of claim 18 wherein the means for effectuating a sealing contact and maintaining the sealing contact comprises a gasket surrounding the closure body, wherein the gasket is manufactured from an elastic material with an elasticity of approximately 40 to 80 shore and comprises an upper circular lip and a lower circular lip each with a thickness of between approximately 0.1 mm and 0.5 mm, wherein the lips join together at their inner circumferences to form a rounded junction point having a radius of between approximately 0.2 mm and 1 mm and diverge at their outer circumferences to provide a generally V-shaped cross-section, wherein the thickness of the gasket at its outer circumference is approximately 1.1 to 1.5 times the thickness of the gasket in the area of the inner circumference.

20. The fuel cap of claim 18 wherein the means for effectuating a sealing contact and maintaining the sealing contact comprises:
a gasket surrounding the closure body; and
a spring surrounding the closure body and positioned above the gasket;
wherein the spring is configured to bias the gasket downward.

21. The fuel cap of claims 20 wherein the means for effectuating a sealing contact and maintaining the sealing contact further comprises a pressure part surrounding the closure body and positioned between the spring and the gasket.

22. A fuel cap for installation and removal relative to a fuel tank filler neck having an upper surface, said fuel cap comprising:
an interior closure body adapted to engage the filler neck through rotation; and
a gasket formed to effectuate a sealing contact between the closure body and the filler neck and maintain the sealing contact through a degree rotation of the body in a cap removal direction up to at least approximately 20°.

23. A fuel cap for installation and removal relative to a fuel tank filler neck having an upper surface, said fuel cap comprising:
an interior closure body adapted to engage the filler neck through rotation;
a gasket surrounding the closure body; and
a gasket biasing system configured to effectuate a sealing contact between the gasket and the filler neck and maintain the sealing contact through a degree rotation of the body in a cap removal direction up to at least approximately 20°.
